(19) United States
(12) Patent Application Publication
(10) Pub. No.: US 2024/0361760 A1
(43) Pub. Date: Oct. 31, 2024

(54) SYSTEM FOR PROVIDING SELF-DIAGNOSTIC, REMEDY AND REDUNDANCY OF AUTONOMIC MODULES IN A MANAGEMENT MESH AND APPLICATION THEREOF

(71) Applicant: American Megatrends International, LLC, Duluth, GA (US)

(72) Inventors: Chitrak Gupta, Kolkata (IN); Venkatesan Balakrishnan, Chennai (IN); Anurag Bhatia, Sugar Hill, GA (US)

(21) Appl. No.: 18/138,847

(22) Filed: Apr. 25, 2023

(51) Int. Cl. G05B 23/02

(52) U.S. Cl. CPC G05B 23/0243; G05B 2223/02

(57) ABSTRACT

A system is provided for providing self-diagnostic, remedy and redundancy of autonomic modules in a management mesh. The system defines a plurality of hierarchy clusters and a plurality of families in each hierarchy cluster. Each node of the system is configured as a master node of a corresponding hierarchy cluster or one of a plurality of management nodes of the corresponding hierarchy cluster. Specifically, each management node of the corresponding hierarchy cluster belongs to one family of the corresponding hierarchy cluster. In operation, the master node of the corresponding hierarchy cluster is configured to manage the management nodes of the corresponding hierarchy cluster and communicate with a management application of the system. The system allows automatic addition of new management nodes into a corresponding hierarchy cluster, and provides automation features to perform resource management, remedial actions and redundancy management of the nodes.

### FIELD

The present disclosure relates generally to management controller technology, and more particularly to a system for providing self-diagnostic, remedy and redundancy of autonomic modules in a management mesh and applications thereof.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The increasing complexity and diversity of current computer systems have made the existing computer infrastructure difficult to manage and insecure. This has led researchers to consider an alternative approach for computer systems design, which is based on principles used by biological systems to deal with complexity, heterogeneity and uncertainty, the approach being referred to as autonomic computing. Autonomic computing is a new paradigm in computing systems design for computer systems that are self-configuring, i.e., automatically configuring components, self-healing, i.e. automatically discovering and correcting faults, self-optimizing, i.e., automatically monitoring and controlling resources to ensure the optimal functioning with respect to the defined requirements, and self-protecting, i.e., providing proactive identification and protection from arbitrary attacks. Autonomic computing solves the management problem of today's complex computing systems by embedding the management of such systems inside the systems themselves, freeing users from potentially overwhelming details.

Normally, the autonomic management element is designed to manage everything in a computer system from the physical hardware through the operating system (OS) up to and including software applications. So far, an existing development of autonomic management elements has been limited to situations where only one autonomic management element has been required.

However, in view of the ever-growing complexity of computer systems, there are numerous situations where a plurality of autonomic management elements needs to operate in agreement to provide a holistic management of the entire computer system. Accordingly, there is a need in the data center to offload the management intelligence to distributed nodes and emulate a self-sustaining platform.

To achieve that, most autonomic systems base their ideas on a master slave concept. For example, U.S. Pat. No. 9,038,069 discloses a method and system for managing a computing system by using a hierarchy of autonomic management elements, where the autonomic management elements operate in a master-slave mode and negotiate a division of management responsibilities regarding various components of the computing system. However, with large data centers with multitude of distributed nodes a paradigm emulating a human society and family for control and sustenance seems a logical management architecture.

Therefore, an unaddressed need exists in the art to address the aforementioned deficiencies and inadequacies.

### SUMMARY

Certain aspects of the disclosure direct to a computing device, which includes a processor and a storage device storing computer executable code. The computer executable code, when executed at the processor, is configured to designate the computing device as one of a plurality of nodes in a system. The system defines a plurality of hierarchy clusters and a plurality of families in each of the hierarchy clusters, and each of the nodes of the system is a master node of a corresponding hierarchy cluster of the hierarchy clusters or one of a plurality of management nodes of the corresponding hierarchy cluster. Each of the management nodes of the corresponding hierarchy cluster belongs to one of the families of the corresponding hierarchy cluster. The master node of the corresponding hierarchy cluster is configured to manage the management nodes of each of the families of the corresponding hierarchy cluster and communicate with a management application of the system.

In certain embodiments, the computing device is a baseboard management controller.

In certain embodiments, the computing device is configured as the master node of the corresponding hierarchy cluster, and the computer executable code, when executed at the processor, is configured to: provide an application programming interface (API) manager to communicate with the management application, wherein the management application is configured to fetch information of the hierarchy clusters of the system or information of the management nodes of each of the hierarchy clusters of the system through the API manager; monitor and manage the management nodes of the corresponding hierarchy cluster and services provided by the management nodes of the corresponding hierarchy cluster; and perform an automatic addition process to add a new management node and register a plurality of services provided by the new management node into the corresponding hierarchy cluster.

In certain embodiments, the computer executable code, when executed at the processor, is configured to monitor and manage the management nodes of each of the families of the corresponding hierarchy cluster and services provided by the management nodes of each of the families of the corresponding hierarchy cluster by: receiving events from one of the management nodes of the corresponding hierarchy cluster; and processing the events to obtain the information of the management nodes of the corresponding hierarchy cluster.

In certain embodiments, the computer executable code, when executed at the processor, is further configured to: in response to determining, based on the information obtained in processing the events, that a corresponding action is required, control an automation engine in the corresponding hierarchy cluster to perform the corresponding action, wherein the corresponding action is a resource management action, a remedial management action, or a redundancy management action.

In certain embodiments, the automation engine is a service provided by a corresponding one of the management nodes of the corresponding hierarchy cluster, and the computer executable code, when executed at the processor, is configured to control the automation engine in the corresponding hierarchy cluster to perform the corresponding action by: generating a script related to the corresponding action; and sending the script to the corresponding one of the management nodes of the corresponding hierarchy cluster to control the automation engine to perform the corresponding action.

In certain embodiments, the computer executable code, when executed at the processor, is configured to perform the automatic addition process by: receive an identity profile being advertised by the new computing device, wherein the identity profile includes information identifying the new computing device and information of services provided by the new computing device; in response to receiving the identity profile, compare the identity profile with existing identity profiles of the management nodes of the corresponding hierarchy cluster to determine the new computing device as a new management node in a corresponding family of the families of the corresponding hierarchy cluster, and store the identity profile of the new computing device as the new management node of the corresponding family; and send an identifier to the new computing device, wherein the identifier includes information of the corresponding hierarchy cluster, information of the master node of the corresponding hierarchy cluster, and information indicating the new computing device as the new management node of the corresponding family.

In certain embodiments, the computer executable code, when executed at the processor, is further configured to deploy a plurality of manageabilities of the master node to a remote computing device, wherein the remote computing device is an accelerator device or a host computing device of the computing device.

In certain embodiments, the computing device is configured as the one of the plurality of management nodes of a corresponding family of the families of the corresponding hierarchy cluster, and the computer executable code, when executed at the processor, is configured to: provide a plurality of services for the corresponding hierarchy cluster; and receive an instruction from the master node of the corresponding hierarchy cluster to perform peer management and monitor the plurality of management nodes of the corresponding family.

In certain embodiments, the services include an automation engine configured to perform a corresponding action based on a script received from the master node of the corresponding hierarchy cluster, and the corresponding action is a resource management action, a remedial management action, or a redundancy management action.

In certain embodiments, the computing device is a new computing device to be added as a new management node to the system, and the computer executable code, when executed at the processor, is configured to: advertise an identity profile of the computing device, wherein the identity profile includes information identifying the computing device and information of services provided by the computing device; and receive an identifier from the master node of the corresponding hierarchy cluster, wherein the identifier includes information of the corresponding hierarchy cluster, information of the master node of the corresponding hierarchy cluster, and information indicating the new computing device as the new management node of a corresponding family of the families of the corresponding hierarchy.

Certain aspects of the disclosure direct to a system, which includes: a plurality of computing devices, wherein each of the computing devices comprises a processor and a storage device storing computer executable code, wherein the computer executable code, when executed at the processor of a specific computing device of the computing devices, is configured to designate the specific computing device as one of a plurality of nodes of the system, wherein the system defines a plurality of hierarchy clusters and a plurality of families in each of the hierarchy clusters, and each of the nodes of the system is a master node of a corresponding hierarchy cluster of the hierarchy clusters or one of a plurality of management nodes of the corresponding hierarchy cluster, wherein each of the management nodes of the corresponding hierarchy cluster belongs to one of the families of the corresponding hierarchy cluster; and a management computing device communicatively connected to the computing devices, and configured to provide a management application, wherein the master node of the corresponding hierarchy cluster is configured to manage the management nodes of each of the families of the corresponding hierarchy cluster and communicate with the management application of the system.

In certain embodiments, the master node of the corresponding hierarchy cluster is configured to: provide an application programming interface (API) manager to communicate with the management application, wherein the management application is configured to fetch information of the hierarchy clusters of the system or information of the management nodes of each of the hierarchy clusters of the system through the API manager; monitor and manage the management nodes of the corresponding hierarchy cluster and services provided by the management nodes of the corresponding hierarchy cluster; and perform an automatic addition process to add a new management node and register a plurality of services provided by the new management node into the corresponding hierarchy cluster.

In certain embodiments, the master node of the corresponding hierarchy cluster is configured to monitor and manage the management nodes of each of the families of the corresponding hierarchy cluster and services provided by the management nodes of each of the families of the corresponding hierarchy cluster by: receiving events from one of the management nodes of the corresponding hierarchy cluster; and processing the events to obtain the information of the management nodes of the corresponding hierarchy cluster.

In certain embodiments, the master node of the corresponding hierarchy cluster is further configured to: in response to determining, based on the information obtained in processing the events, that a corresponding action is required, control an automation engine in the corresponding hierarchy cluster to perform the corresponding action, wherein the corresponding action is a resource management action, a remedial management action, or a redundancy management action.

In certain embodiments, the automation engine is a service provided by a corresponding one of the management nodes of the corresponding hierarchy cluster, and the master node of the corresponding hierarchy cluster is configured to control the automation engine in the corresponding hierarchy cluster to perform the corresponding action by: generating a script related to the corresponding action; and sending the script to the corresponding one of the management nodes of the corresponding hierarchy cluster to control the automation engine to perform the corresponding action.

In certain embodiments, the master node of the corresponding hierarchy cluster is configured to perform the automatic addition process by: receiving an identity profile being advertised by the new computing device, wherein the identity profile includes information identifying the new computing device and information of services provided by the new computing device; in response to receiving the identity profile, comparing the identity profile with existing identity profiles of the management nodes of the corresponding hierarchy cluster to determine the new computing device as a new management node in a corresponding family of the families of the corresponding hierarchy cluster, and storing the identity profile of the new computing device as the new management node of the corresponding family; and sending an identifier to the new computing device, wherein the identifier includes information of the corresponding hierarchy cluster, information of the master node of the corresponding hierarchy cluster, and information indicating the new computing device as the new management node of the corresponding family; wherein the new computing device is configured to advertise the identity profile of the computing device, and to receive the identifier from the master node of the corresponding hierarchy cluster to indicate the new computer as the new management node of the corresponding family.

In certain embodiments, the master node of the corresponding hierarchy cluster is further configured to deploy a plurality of manageabilities of the master node to a remote computing device, wherein the remote computing device is an accelerator device or a host computing device of the computing device.

In certain embodiments, the one of the plurality of management nodes of a corresponding family of the families of the corresponding hierarchy cluster is configured to: provide a plurality of services for the corresponding hierarchy cluster; and receive an instruction from the master node of the corresponding hierarchy cluster to perform peer management and monitor the plurality of management nodes of the corresponding family.

In certain embodiments, the services include an automation engine configured to perform a corresponding action based on a script received from the master node of the corresponding hierarchy cluster, and the corresponding action is a resource management action, a remedial management action, or a redundancy management action.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1A schematically depicts an exemplary system in a standard paradigm according to certain embodiments of the present disclosure.

FIG. 1B schematically depicts an exemplary system in a group manager paradigm according to certain embodiments of the present disclosure.

FIG. 1C schematically depicts an exemplary system in an autonomic multi-master group paradigm according to certain embodiments of the present disclosure.

FIG. 2 schematically depicts an exemplary system in an autonomic hierarchy according to certain embodiments of the present disclosure.

FIG. 3 schematically depicts an exemplary computing device as a node of the system as shown in FIG. 2 according to certain embodiments of the present disclosure.

FIG. 4A schematically depicts a master node of a corresponding hierarchy cluster according to certain embodiments of the present disclosure.

FIG. 4B schematically depicts a management node of a corresponding hierarchy cluster according to certain embodiments of the present disclosure.

FIG. 5A schematically depicts services provided by a service manager of a master node of a corresponding hierarchy cluster according to certain embodiments of the present disclosure.

FIG. 5B schematically depicts services provided by a service manager of a management node of a corresponding hierarchy cluster according to certain embodiments of the present disclosure.

FIG. 6 schematically depicts a table showing information of an identity profile being advertised by a new computing device according to certain embodiments of the present disclosure.

FIG. 7 schematically depicts exemplary communication between a master node and new computing devices by LLDP broadcasts according to certain embodiments of the present disclosure.

FIG. 8 schematically depicts an exemplary automatic addition process to add new management nodes into a hierarchy cluster according to certain embodiments of the present disclosure.

FIG. 9 schematically depicts an exemplary monitoring process by the master node to the management nodes in the hierarchy cluster according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

Certain embodiments of the present disclosure relate to computer technology. As depicted in the drawings, computer components may include physical hardware components and virtual software components, which are shown schematically as blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

As discussed above, there is a need in the data center to offload the management intelligence to distributed nodes and emulate a self-sustaining platform. In view of the deficiency, certain aspects of the present invention provides a system that allows communication between autonomic nodes to disseminate diagnostic information and provide remedial action thereafter. The system provides a novel solution of advertising events to autonomic groups and finding remedial actions or in cases of unrecoverable failure, enable redundant mode of operations in an autonomic mesh.

Autonomic computing has become mainstream within computing, and has four key self-managing properties:
(1) Self-configuring: Enable auto configuration of a node based on trained parameters;
(2) Self-healing: Enable diagnostics and remedial actions on service processors or devices;
(3) Self-optimizing: Enable performance management based on request scale; and
(4) Self-protecting: Enable system protection from threats like electrical outages, overheating and security attacks.

Specifically, system management becomes more and more complex by moving from management of single nodes to managing multiple nodes, clusters and data centers. With multiple nodes to manage in a data center, the focus is on an intelligent and automated management system and the corresponding management method.

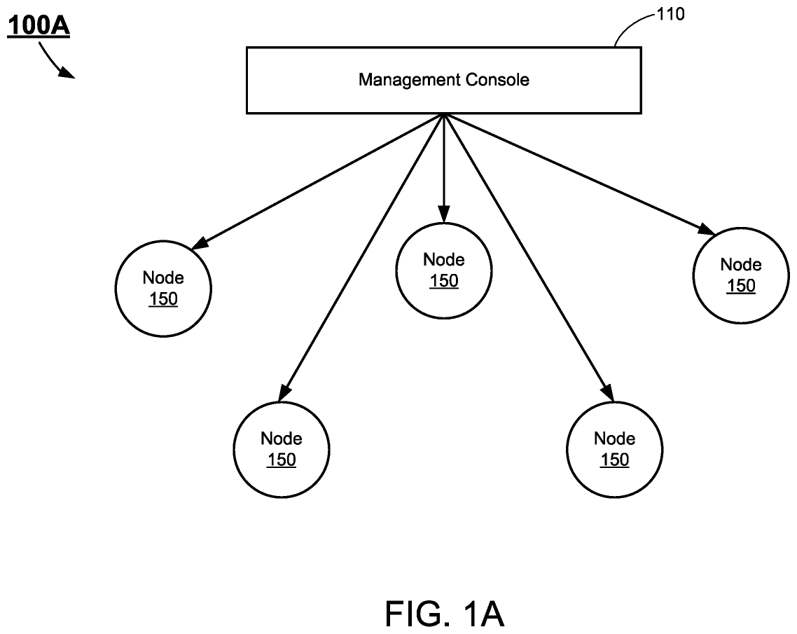

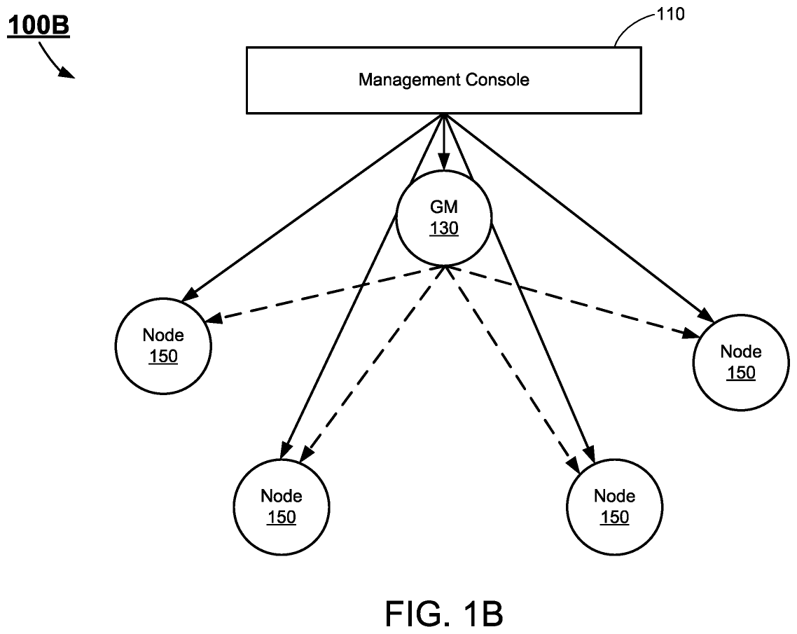

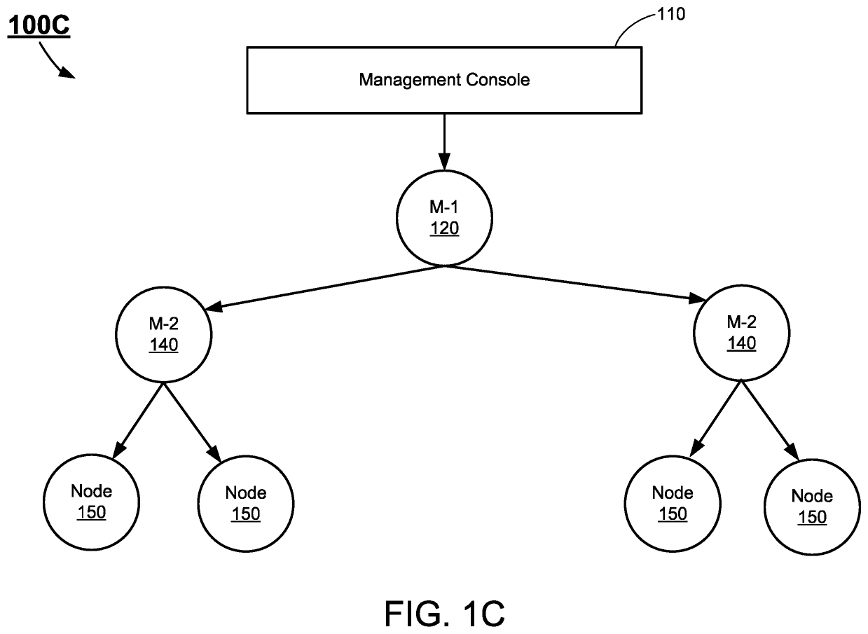

FIGS. 1A to 1C schematically depict several exemplary systems in different paradigms according to certain embodiments of the present disclosure, which are provided for showing the evolution of distributed management entities. Specifically, FIG. 1A schematically depicts an exemplary system in a standard paradigm 100A, which includes a management console 110 (which may be a management application executed on a management computing device or platform) directly and individually managing each of a plurality of nodes 150. In comparison, FIG. 1B schematically depicts an exemplary system in a group manager paradigm 110B, in which a group manager (GM) node 130 is provided in the nodes 150. In the group manager paradigm 110B, the management console 110 may still manage each nodes 150 directly and individually, but the GM node 130 may collate other nodes 150 for management, such that the other nodes 150 essentially function as sub nodes for the GM node 130. Further, FIG. 1C schematically depicts an exemplary system in an autonomic multi-master group paradigm 100C, which in which a primary master (M-1) node 120 and two secondary master (M-2) nodes 140 are provided in the nodes 150. In the autonomic multi-master group paradigm 100C, the management console 110 communicates directly to the primary master (M-1) node 120, which in turn manages the two secondary master (M-2) nodes 140 and their subgroups of the nodes 150.

In the standard paradigm of manageability, a single node provides interfaces such as application programming interfaces (APIs) or command line interfaces (CLIs) to management applications that are used by administrators. Many OEMs utilize the group manager paradigm, which provide grouped management of nodes where there is a master node that manages multiple nodes and provides abstraction to administrators. Nevertheless, autonomic hierarchical management is a new paradigm of systems management where managed nodes form familial groups based on certain parameters and enable aggregated lifecycle management of each other in a management mesh.

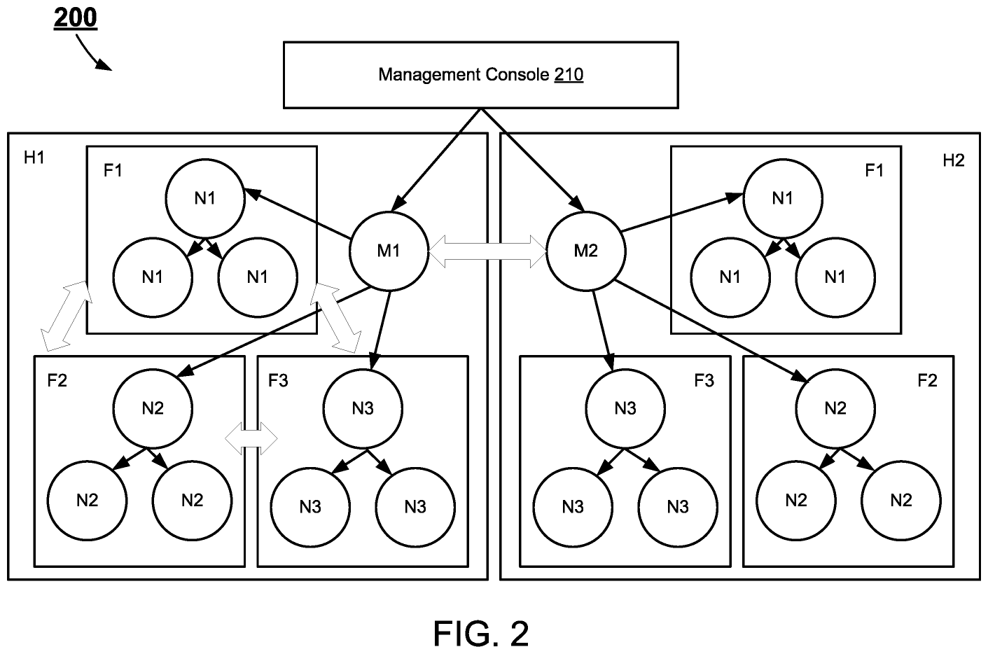

FIG. 2 schematically depicts an exemplary system in an autonomic hierarchy according to certain embodiments of the present disclosure. As shown in FIG. 2, the exemplary system 200 is an implementation to expand the concept of manageability groups in an autonomic hierarchy, which has a management console 210 and a plurality of nodes. Specifically, the system 200 defines a plurality of hierarchy clusters Hx and a plurality of families Fy in each of the hierarchy clusters, where x and y are positive integers. For example, FIG. 2 shows two hierarchy clusters H1 and H2, and each hierarchy cluster includes three families F1, F2 and F3. Further, the nodes of the system 200 include two master nodes M1 and M2 respectively corresponding to the two hierarchy clusters H1 and H2, as well as a plurality of management nodes being managed respectively by the master nodes M1 and M2. Using the hierarchy cluster H1 as an example, the hierarchy cluster H1 has a corresponding master node M1, and the management nodes of the hierarchy cluster H1 are distributed in the three families F1, F2 and F3, such that each of the management nodes of the hierarchy cluster H1 belongs to one of the three families F1, F2 and F3 of the hierarchy cluster H1. As shown in FIG. 2, each family includes three management nodes. However, the quantities of the management nodes of the families may be different. For example, one family may have more or fewer management nodes than another family. In this case, the management console 210 has knowledge of the two master nodes M1 and M2, and the rest of the manageability aspect is self-sustaining internally in each hierarchy cluster.

In each hierarchy cluster, the management nodes are responsible for managing the whole hierarchy cluster with different families F1, F2 and F3 of the management nodes. The master nodes M1 and M2 respectively provide management APIs to the management application to fetch information about the complete hierarchy clusters correspondingly. Moreover, in each hierarchy cluster, the master node may or may not provide dedicated node management service, but is completely responsible for the management of all other nodes in the hierarchy.

In certain embodiments, as shown in FIG. 2, instead of having all of the management nodes in a single hierarchy cluster to be managed and monitored by the master node, one of the management nodes in each family may be controlled or instructed by the master node to perform peer management and monitor the other management nodes of the corresponding family. In this case, the management node performing peer management and monitoring essentially functions as a secondary master node in the corresponding family.

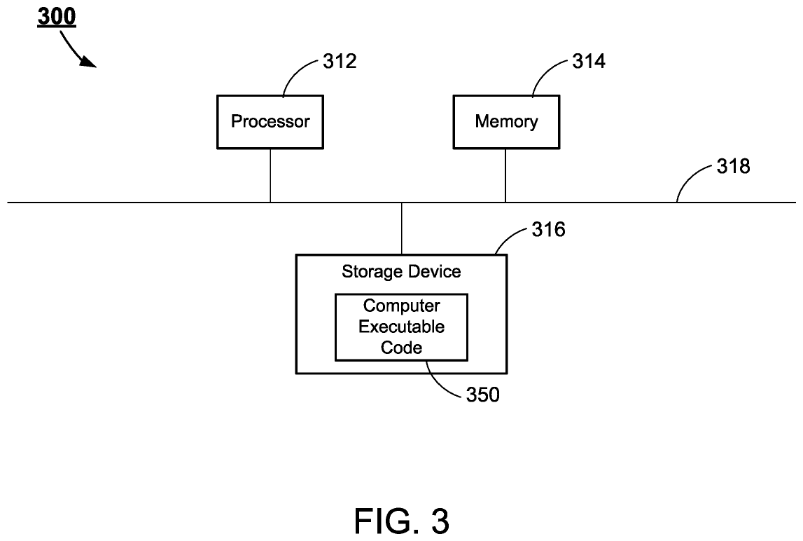

FIG. 3 schematically depicts an exemplary computing device as a node of the system as shown in FIG. 2 according to certain embodiments of the present disclosure. Specifically, the computing device 300 as shown in FIG. 3 may be implemented by a baseboard management controller (BMC), an on-board accelerator device such as a FPGA, GPGPU, or other types of computing devices. As shown in FIG. 3, the computing device 300 includes a processor 312, a memory 314, and a storage device 316 interconnected by a bus 318. Further, the computing device 300 may include other hardware components and software components (not shown) to perform its corresponding tasks. Examples of these hardware and software components may include, but not limited to, other required memory, interfaces, buses, network interfaces, I/O modules and peripheral devices.

The processor 312 is configured to control operation of the computing device 300. In certain embodiments, the processor 312 may be a central processing unit (CPU), or may be other types of processors. The processor 312 can execute or access computer executable code or instructions of the computing device 300 or other applications and instructions of the computing device 300. In certain embodiments, the computing device 300 may run on more than one processor, such as two processors, four processors, eight processors, or any suitable number of processors.

The memory 314 can be a volatile memory, such as the random-access memory (RAM), for storing the data and information during the operation of the computing device 300. In certain embodiments, the memory 314 may be a volatile memory array. In certain embodiments, the computing device 300 may include multiple volatile memory modules 314.

The storage device 316 is a non-volatile data storage media for storing the applications of the computing device 300. Examples of the storage device 316 may include flash memory, memory cards, USB drives, hard drives, floppy disks, optical drives, or any other types of non-volatile data storage devices. In certain embodiments, the computing device 300 may have multiple non-volatile memory modules 316, which may be identical storage devices or different types of storage devices, and the applications may be stored in one or more of the storage device 316 of the computing device 300.

As shown in FIG. 3, the storage device 316 of the computing device 300 stores computer executable code 350. In certain embodiments, the storage device 316 may include other applications, modules or data necessary for the operation of the computing device 300. It should be noted that the computer executable code 350 may be forms to be or as a part of a software image. In certain embodiments, the computer executable code 350 may further include sub-systems or sub-modules. Alternatively, the computer executable code 350 may be combined with other software modules as one stack.

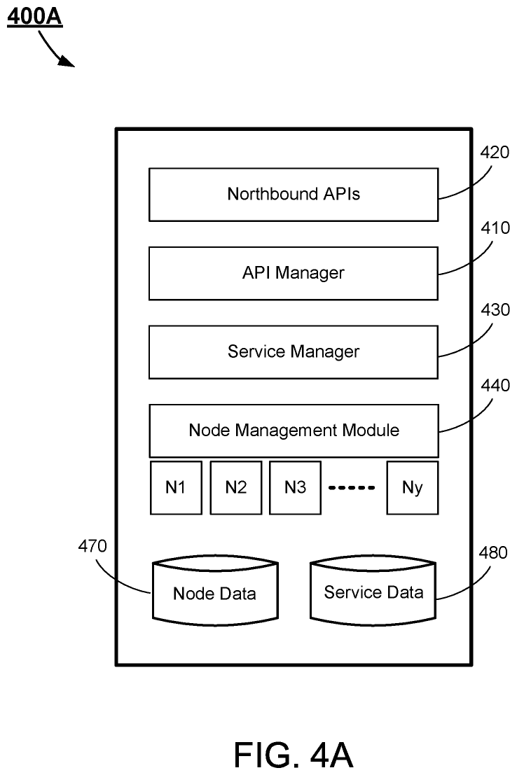

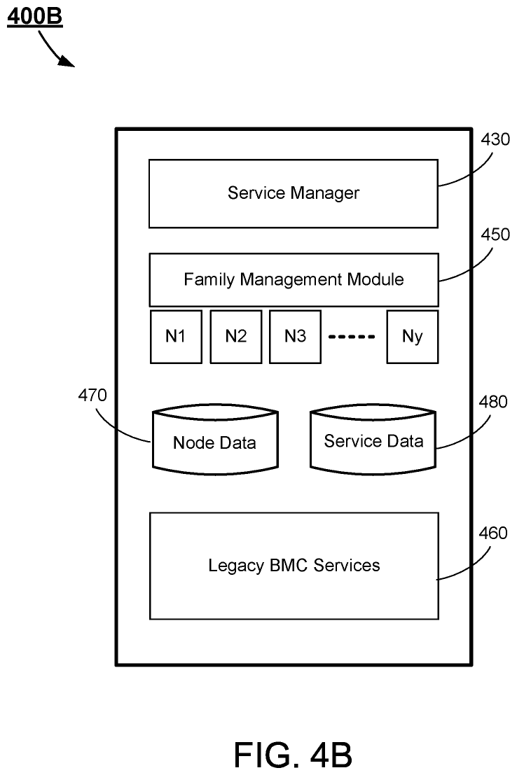

As discussed, the computing device as shown in FIG. 3 is provided to function as a node of the system as shown in FIG. 2. FIGS. 4A and 4B schematically depicts examples of the computer executable code 350 of different nodes of a corresponding hierarchy cluster according to certain embodiments of the present disclosure. It should be particularly noted that the exemplary modules as shown in each of FIGS. 4A and 4B are provided as examples of the computer executable code 350 of different nodes, and are thus not intended to limit the present disclosure thereto.

FIG. 4A schematically depicts a master node of a corresponding hierarchy cluster according to certain embodiments of the present disclosure. As shown in FIG. 4A, the master node 400A includes an API manager module 410, northbound APIs 420, a service manager module 430, a node management module 440, and databases 470 and 480 respectively storing node data and service data of the corresponding hierarchy cluster.

The API manager module 410 is used to provide an API manager, which is used to manage the northbound APIs 420 to communicate with the management application (i.e., the management console 210 as shown in FIG. 2) of the system. In operation, the management application may fetch information of the hierarchy clusters of the system or information of the management nodes of each of the hierarchy clusters of the system through the API manager.

The service manager module 430 is used to provide a service manager, which is the core of the solution. In operation, in the master node, the service manager is in charge to control the node management module 440 to monitor and manage the management nodes of the corresponding hierarchy cluster and services provided by the management nodes of the corresponding hierarchy cluster, and to store or access the information of node data and service data of the corresponding hierarchy cluster in the databases 470 and 480. Further, the service manager is also in charge to perform corresponding automatic operations to the management nodes of the corresponding hierarchy cluster. Examples of the automatic operations may include, without being limited thereto, performing an automatic addition process to add a new management node and register a plurality of services provided by the new management node into the corresponding hierarchy cluster; processing events received from the management nodes to obtain the information of the management nodes of the corresponding hierarchy cluster; determining, based on the information obtained in processing the events, whether a corresponding action is required; when determining that such a corresponding action is required, controlling an automation engine in the corresponding hierarchy cluster to perform the corresponding action, such as a resource management action, a remedial management action, or a redundancy management action; and deploying a plurality of manageabilities of the master node to a remote computing device when the master node is overwhelmed. Details of the operations of the service manager will be described later.

The node management module 440 is a module to monitor and manage the management nodes of the corresponding hierarchy cluster and services provided by the management nodes of the corresponding hierarchy cluster. As shown in FIG. 2, in each hierarchy cluster, the master node is to monitor and manage the management nodes of the corresponding hierarchy cluster and services provided by the management nodes of the corresponding hierarchy cluster. In operation, the node management module 440 may receive events from one of the management nodes of the corresponding hierarchy cluster, and send the events received to the service manager for further processing. In certain embodiments, the node management module 440 of the master node may subscribe for events from each management node registered in the corresponding hierarchy cluster. Thus, each management node may provide events to the master node. The events may be in Redfish or dbus format encapsulated as a network packet.

FIG. 4B schematically depicts a management node of a corresponding hierarchy cluster according to certain embodiments of the present disclosure. As shown in FIG. 4B, the management node 400B includes a service manager module 430, a family management module 450, a legacy BMC services module 460, and databases 470 and 480 respectively storing node data and service data of the corresponding hierarchy cluster. It should be noted that the management node 400B does not require the API manager module 410 and the northbound APIs 420 as shown in FIG. 4A, as the management node 400 is not required to communicate with the management application.

The service manager module 430 is used to provide a service manager. In operation, the service manager is used to first advertise the management node to be accepted into a hierarchy cluster under a master node. Once being accepted and registered as a management node, the service manager may post events to the master node, and when being instructed by the master node, the service manager may perform the corresponding action, such as a resource management action, a remedial management action, or a redundancy management action. Further, when being instructed by the master node, the service manager in the management node may be in charge to control the family management module 450 to monitor and manage other management nodes of the corresponding family and services provided by the other management nodes of the corresponding family, and to store or access the information of node data and service data of the corresponding hierarchy cluster in the databases 470 and 480. Details of the operations of the service manager will be described later.

The family management module 450 is a module similar to the node management module 440 of the master node, which is used to monitor and manage the management nodes of the corresponding family and services provided by the management nodes of the corresponding family. As shown in FIG. 2, in each family, one of the management nodes may function as a secondary master node, such that the secondary master node may monitor and manage the management nodes of the corresponding family and services provided by the management nodes of the corresponding family. In operation, the family management module 450 may receive events from the other management nodes of the corresponding family, and send the events received to the service manager for further processing or forwarding the events to the master node.

The legacy BMC services module 460 is a module providing all of the legacy BMC services. In certain embodiments, the BMC services may function as client services for actions initiated by the master node of the corresponding hierarchy cluster. It should be noted that the actual BMC services provided in each BMC may vary, and it is possible that a hierarchy cluster may include management nodes that provide different legacy BMC services, such that all of the management nodes may work together to maintain a full service package of the hierarchy cluster.

In certain embodiments, the roles of a node in a corresponding hierarchy cluster may be dynamic by changing settings of the service manager. For example, a computing device may include all of the modules as shown in FIGS. 4A and 4B, and by changing the settings of the service manager, the roles of the node may be dynamically switchable between a master node and a management node. In certain embodiments, the switching of the roles may occur in the remedial management action or the redundancy management action.

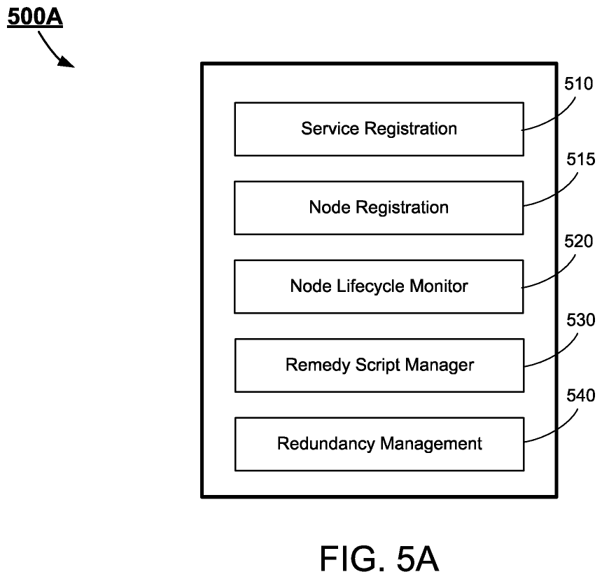

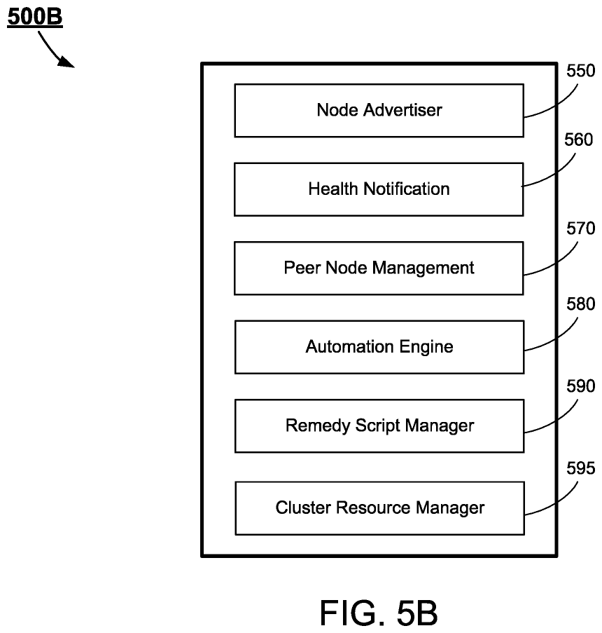

FIGS. 5A and 5B schematically depict exemplary services provided by the service manager of the master node and the management node of a corresponding hierarchy cluster according to certain embodiments of the present disclosure. It should be particularly noted that the exemplary service modules as shown in each of FIGS. 5A and 5B are provided as examples of the service manager 430 of different nodes, and are thus not intended to limit the present disclosure thereto.

FIG. 5A schematically depicts services provided by a service manager of a master node of a corresponding hierarchy cluster. As shown in FIG. 5A, the service manager 500A includes a service registration module 510, a node registration module 515, a node lifecycle monitor module 520, a remedy script manager 530, and a redundancy management module 540.

The service registration module 510 and the node registration module 515 are used in the automatic addition process to add a new management node and register a plurality of services provided by the new management node into the corresponding hierarchy cluster. Specifically, the service registration module 510 and the node registration module 515 provide the functionalities of listening to the incoming broadcast or advertised packets from new computing devices intended to be added as new nodes, and register theses new computing devices in appropriate hierarchy clusters and/or families. In the automatic addition process, the service manager of the master node may receive an identity profile being advertised by a new computing device with the intent to be added as a new management node to the system. The identity profile includes information identifying the new computing device and information of services provided by the new computing device.

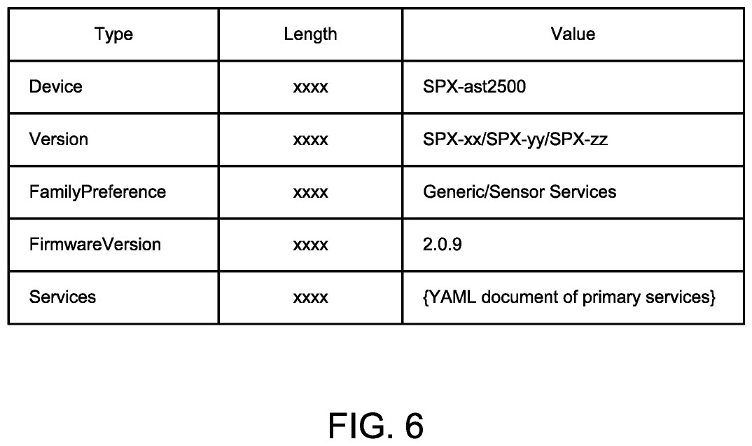

FIG. 6 schematically depicts a table showing information of an identity profile being advertised by a new computing device according to certain embodiments of the present disclosure. As shown in FIG. 6, the identity profile may include information related to the type of the device and the corresponding version, information of the family preference (which identifies the corresponding types of services provided by the new computing device), the firmware version, as well as a list of the services being provided. In response to receiving the identity profile, the service manager may compare the identity profile with existing identity profiles of the management nodes of the corresponding hierarchy cluster to determine the new computing device as a new management node in a corresponding family of the corresponding hierarchy cluster. For example, as shown in FIG. 6, the identity profile is in a type-length-value (TLV) structure, which provides the information of the family preference being related to generic/sensor services. Thus, the master node may assign the new computing device as a new management node in the family related to generic services or in the family related to sensor services. Once the determination is made, the service manager may utilize the service registration module 510 and the node registration module 515 to register the new management node and the corresponding services being provided, and store the identity profile of the new computing device as the new management node of the corresponding family. Further, the node registration module 515 may send an identifier to the new computing device for identification purposes. Specifically, the identifier may include information of the corresponding hierarchy cluster, information of the master node of the corresponding hierarchy cluster, and information indicating the new computing device as the new management node of the corresponding family. For example, an exemplary identifier may include the information of <master-node>/<hierarchy-name>/<assigned-name>, in which the assigned name may be derived from the device property of the identity profile received from the new computing device.

Referring back to FIG. 5A, the node lifecycle monitor module 520, the remedy script manager 530 and the redundancy management module 540 are used for processing the events received from the management nodes and control the automation engine in the corresponding hierarchy cluster to perform the corresponding action. Specifically, the node lifecycle monitor module 520 is in charge of processing the events to obtain the information of the management nodes of the corresponding hierarchy cluster, and to determine whether the information indicates that a corresponding action is required. For example, if the node lifecycle monitor module 520 determines that a remedial management action is required, the node lifecycle monitor module 520 activates the remedy script manager 530 to generate a remedy script, which may be in the format of an IPMI command or a series of instructions in any supported scripting language, for the purpose of calling the automation engine in one of the management node to perform the corresponding remedial management action. Similarly, if the node lifecycle monitor module 520 determines that a redundancy management action is required, the node lifecycle monitor module 520 activates the redundancy management module 540 to deploy certain corresponding services to a remote computing device and/or a management node, such that redundant services are available in the corresponding hierarchy cluster.

It should be noted that, for the master node in a hierarchy cluster, processing each and every event from all of the management nodes may be cumbersome. In certain embodiments, the master node may assign one of the management nodes in some of the families to pick up the peer events and perform the corresponding action, such as disseminating any known remedy script to an automation Engine running on the node. Alternatively, in certain embodiments, the master node may choose to ignore noncritical events or wait for some time to check for a management node to process the event before it takes an action.

In certain embodiments, one of the management nodes may run certain services that may start consuming lot of resources, thus making the system unstable. Usually, each service would have resource management defined by cgroups in systemd service files. However, the master node may monitor resources, like CPU usage and memory usage, of the management nodes, and perform a resource management action similar to the remedial management action by activating the remedy script manager 530 to generate a resource management or rearrangement script in order to call the automation engine to perform the corresponding resource management action. The resource management scripts with altered resource allocations may be pushed to the management nodes to update and respawn the process that are consuming resources.

FIG. 5B schematically depicts services provided by a service manager of a management node of a corresponding hierarchy cluster. As shown in FIG. 5B, the service manager 500B includes a node advertiser 550, a health notification module 560, a peer node management module 570, an automation engine 580, a remedy script manager 590, and a cluster resource manager 595.

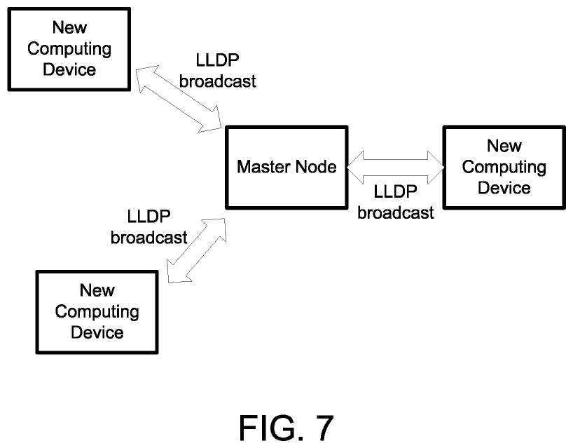

The node advertiser 550 is used for advertising the management node (or more precisely, a new computing device before it is assigned as a new management node) in order to be accepted into a hierarchy cluster. Specifically, the node advertiser 550 includes an identity profile of the computing device, such as the exemplary identity profile as shown in FIG. 6. The node advertiser 550 may advertise or broadcast the identity profile, such that a master node may receive the identity profile and accept the computing device as a new management node. For example, the node advertiser 550 may may share the identity profile through Link Layer Discovery Protocol (LLDP) broadcast. LLDP is a layer 2 neighbor discovery protocol that allows devices to advertise device information to their directly connected peers/neighbors, and the identity profile in a TLV formatted identity string may be made part of the LLDP discovery packet. FIG. 7 schematically depicts exemplary communication between a master node and new computing devices by LLDP broadcasts according to certain embodiments of the present disclosure. Once the master node receives the identity profile and registers the new management node, the master node will send an identifier back to the new management node, and the node advertiser 550 will receive the identifier.

The health notification module 560 is a module monitoring and generating events related to the health of the management node. Specifically, whenever the health notification module 560 generates an event, the health notification module 560 forwards the event to the master node.

The peer node management module 570 is used for the management node to perform peer management. As discussed, the master node may assign one of the management nodes in some of the families to pick up the peer events. When the management node receives the instruction from the master node to perform peer management, the peer node management module 570 may perform the corresponding peer management and monitor the other management nodes of the corresponding family.

The automation engine 580 is a service configured to perform the corresponding action based on the script received from the master node of the corresponding hierarchy cluster. As discussed above, the corresponding action may be a resource management action, a remedial management action, or a redundancy management action. It should be noted that, in a hierarchy cluster, there may be multiple management node having multiple automation engines, and each automation engine may be responsible for different corresponding actions. For example, one management node may have an automation engine dedicated for the resource and redundancy management actions, and another management node may have an automation engine dedicated for the remedial management actions.

The remedy script manager 590 and the cluster resource manager 595 are modules similar to the remedy script manager 530 in the master node. As discussed above, the master node may be overwhelmed in processing all of the events, and in this case, the master node may assign one of the management nodes in some of the families to pick up the peer events and perform the corresponding action. In this case, the remedy script manager 590 and the cluster resource manager 595 of the management node may perform the corresponding actions, such as disseminating any known remedy script to an automation engine 580 running on the node.

As discussed above, the roles of a node in a corresponding hierarchy cluster may be dynamic by changing settings of the service manager. For example, the service manager in a computing device may include all of the modules as shown in FIGS. 5A and 5B, such that the roles of the computing device may be dynamically switchable between a master node and a management node by changing the settings of the service manager. In certain embodiments, the switching of the roles may occur in the remedial management action or the redundancy management action.

In the embodiments as described above, the system may include multiple computing devices functioning as the nodes. In certain embodiments, one or more the nodes of the system may be implemented by a virtual computing device, such as a virtual machine or other software-emulated device. In certain embodiments, some of the nodes may be implemented as multiple virtual computing device running on the same physical device.

In certain embodiments, for large scale deployments, if the master node is overwhelmed, the master node can be hosted on an on-board accelerator device like FPGA, GPGPU or on the host.

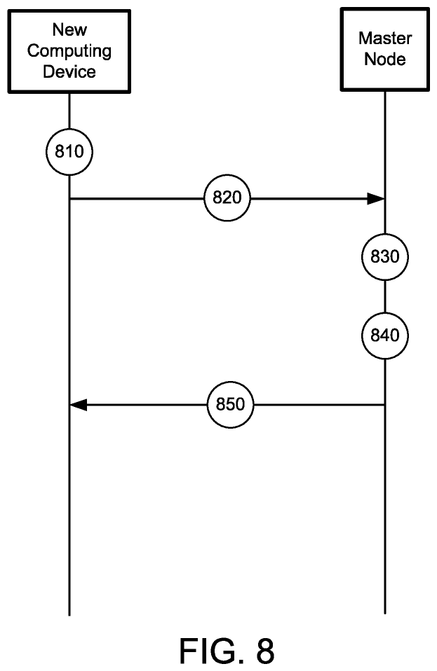

FIG. 8 schematically depicts an exemplary automatic addition process to add new management nodes into a hierarchy cluster according to certain embodiments of the present disclosure. In certain embodiments, the automatic addition process may be implemented by a master node and a new computing device, and each of the master node and the new computing device may be implemented respectively by a computing device as shown in FIG. 3. Specifically, the master node may be implemented by a computing device having the modules as shown in FIGS. 4A and 5A, and the new computing device may be implemented by a computing device having the modules as shown in FIGS. 4B and 5B.

As shown in FIG. 8, at process 810, the new computing device, which intends to be added into the system as a new management node, is provided with an identity profile. At process 820, the new computing device advertises the identity profile, and the master node receives the identity profile being advertised. At process 830, the service manager of the master node may compare the identity profile with existing identity profiles of the management nodes of the corresponding hierarchy cluster to determine the new computing device as a new management node in a corresponding family of the corresponding hierarchy cluster, and perform corresponding processes to register the new management node and the corresponding services being provided. At process 840, the master node generates an identifier for the new management node for identification purposes. Specifically, the identifier may include information of the corresponding hierarchy cluster, information of the master node of the corresponding hierarchy cluster, and information indicating the new computing device as the new management node of the corresponding family. At process 850, the master node sends the identifier to the new computing device, such that the new computing device is now identified as the new management node.

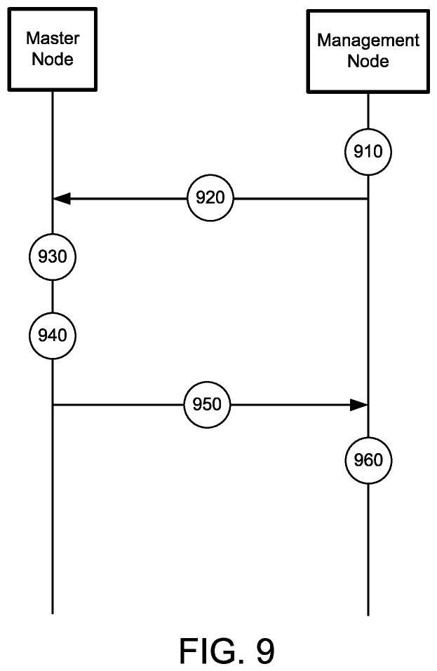

FIG. 9 schematically depicts an exemplary monitoring process by the master node to the management nodes in the hierarchy cluster according to certain embodiments of the present disclosure. In certain embodiments, the automatic addition process may be implemented by a master node and a management node, and each of the master node and the management node may be implemented respectively by a computing device as shown in FIG. 3. Specifically, the master node may be implemented by a computing device having the modules as shown in FIGS. 4A and 5A, and the management node may be implemented by a computing device having the modules as shown in FIGS. 4B and 5B.

As shown in FIG. 9, at process 910, the management node may generate an event. At process 920, the management node sends the event to the master node. At process 930, the master node processes the event to obtain the information of the management node, and determines, based on the information obtained in processing the event, whether a corresponding action is required. If the master node determines that the corresponding action is required, at process 940, the master node generates an instruction to control an automation engine at the management node to perform the corresponding action. At process 950, the master node sends the instruction to the management node. At process 960, the management node performs the corresponding action based on the instruction.

The embodiments of the present disclosure as described above may be used as a systems management solution, providing a system for providing self-diagnostic, remedy and redundancy of autonomic modules in a management mesh, while enabling microservices driven architecture for the users and customers. In certain embodiments, the system allows autonomic management of multiple BMC nodes based on BMC microservices, and enables automatic discovery and registration of management nodes based on personality definitions. Further, the system allows automated remedial actions and redundancy management in failure conditions, while enabling dynamic personalities to the nodes. Moreover, the load of the master BMC nodes may be managed by deploying manageabilities to accelerator nodes for cluster management.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the 10 appended claims rather than the foregoing description and the exemplary embodiments described therein.

What is claimed is:

1. A computing device, comprising:
a processor; and
a storage device storing computer executable code,
wherein the computer executable code, when executed at the processor, is configured to designate the computing device as one of a plurality of nodes in a system, wherein the system defines a plurality of hierarchy clusters and a plurality of families in each of the hierarchy clusters, and each of the nodes of the system is a master node of a corresponding hierarchy cluster of the hierarchy clusters or one of a plurality of management nodes of the corresponding hierarchy cluster, wherein each of the management nodes of the corresponding hierarchy cluster belongs to one of the families of the corresponding hierarchy cluster,
wherein the master node of the corresponding hierarchy cluster is configured to manage the management nodes of each of the families of the corresponding hierarchy cluster and communicate with a management application of the system.

2. The computing device of claim 1, being a baseboard management controller (BMC).

3. The computing device of claim 1, wherein the computing device is configured as the master node of the corresponding hierarchy cluster, and the computer executable code, when executed at the processor, is configured to:
provide an application programming interface (API) manager to communicate with the management application, wherein the management application is configured to fetch information of the hierarchy clusters of the system or information of the management nodes of each of the hierarchy clusters of the system through the API manager;
monitor and manage the management nodes of the corresponding hierarchy cluster and services provided by the management nodes of the corresponding hierarchy cluster; and
perform an automatic addition process to add a new management node and register a plurality of services provided by the new management node into the corresponding hierarchy cluster.

4. The computing device of claim 3, wherein the computer executable code, when executed at the processor, is configured to monitor and manage the management nodes of each of the families of the corresponding hierarchy cluster and services provided by the management nodes of each of the families of the corresponding hierarchy cluster by:
receiving events from one of the management nodes of the corresponding hierarchy cluster; and
processing the events to obtain the information of the management nodes of the corresponding hierarchy cluster.

5. The computing device of claim 4, wherein the computer executable code, when executed at the processor, is further configured to:
in response to determining, based on the information obtained in processing the events, that a corresponding action is required, control an automation engine in the corresponding hierarchy cluster to perform the corresponding action,
wherein the corresponding action is a resource management action, a remedial management action, or a redundancy management action.

6. The computing device of claim 5, wherein the automation engine is a service provided by a corresponding one of the management nodes of the corresponding hierarchy cluster, and the computer executable code, when executed at the processor, is configured to control the automation engine in the corresponding hierarchy cluster to perform the corresponding action by:
generating a script related to the corresponding action; and
sending the script to the corresponding one of the management nodes of the corresponding hierarchy cluster to control the automation engine to perform the corresponding action.

7. The computing device of claim 3, wherein the computer executable code, when executed at the processor, is configured to perform the automatic addition process by:
receiving an identity profile being advertised by the new computing device, wherein the identity profile includes information identifying the new computing device and information of services provided by the new computing device;
in response to receiving the identity profile, comparing the identity profile with existing identity profiles of the management nodes of the corresponding hierarchy cluster to determine the new computing device as a new management node in a corresponding family of the families of the corresponding hierarchy cluster, and storing the identity profile of the new computing device as the new management node of the corresponding family; and
sending an identifier to the new computing device, wherein the identifier includes information of the corresponding hierarchy cluster, information of the master node of the corresponding hierarchy cluster, and information indicating the new computing device as the new management node of the corresponding family.

8. The computing device of claim 3, wherein the computer executable code, when executed at the processor, is further configured to deploy a plurality of manageabilities of the master node to a remote computing device, wherein the remote computing device is an accelerator device or a host computing device of the computing device.

9. The computing device of claim 1, wherein the computing device is configured as the one of the plurality of management nodes of a corresponding family of the families of the corresponding hierarchy cluster, and the computer executable code, when executed at the processor, is configured to:
provide a plurality of services for the corresponding hierarchy cluster; and
receive an instruction from the master node of the corresponding hierarchy cluster to perform peer management and monitor the plurality of management nodes of the corresponding family.

10. The computing device of claim 9, wherein the services include an automation engine configured to perform a corresponding action based on a script received from the master node of the corresponding hierarchy cluster, and the corresponding action is a resource management action, a remedial management action, or a redundancy management action.

11. The computing device of claim 1, wherein the computing device is a new computing device to be added as a new management node to the system, and the computer executable code, when executed at the processor, is configured to:
advertise an identity profile of the computing device, wherein the identity profile includes information identifying the computing device and information of services provided by the computing device; and
receive an identifier from the master node of the corresponding hierarchy cluster, wherein the identifier includes information of the corresponding hierarchy cluster, information of the master node of the corresponding hierarchy cluster, and information indicating the new computing device as the new management node of a corresponding family of the families of the corresponding hierarchy.

12. A system, comprising:
a plurality of computing devices, wherein each of the computing devices comprises a processor and a storage device storing computer executable code, wherein the computer executable code, when executed at the processor of a specific computing device of the computing devices, is configured to designate the specific computing device as one of a plurality of nodes of the system, wherein the system defines a plurality of hierarchy clusters and a plurality of families in each of the hierarchy clusters, and each of the nodes of the system is a master node of a corresponding hierarchy cluster of the hierarchy clusters or one of a plurality of management nodes of the corresponding hierarchy cluster, wherein each of the management nodes of the corresponding hierarchy cluster belongs to one of the families of the corresponding hierarchy cluster; and
a management computing device communicatively connected to the computing devices, and configured to provide a management application, wherein the master node of the corresponding hierarchy cluster is configured to manage the management nodes of each of the families of the corresponding hierarchy cluster and communicate with the management application of the system.

13. The system of claim 12, wherein the master node of the corresponding hierarchy cluster is configured to:
provide an application programming interface (API) manager to communicate with the management application, wherein the management application is configured to fetch information of the hierarchy clusters of the system or information of the management nodes of each of the hierarchy clusters of the system through the API manager;
monitor and manage the management nodes of the corresponding hierarchy cluster and services provided by the management nodes of the corresponding hierarchy cluster; and
perform an automatic addition process to add a new management node and register a plurality of services provided by the new management node into the corresponding hierarchy cluster.

14. The system of claim 13, wherein the master node of the corresponding hierarchy cluster is configured to monitor and manage the management nodes of each of the families of the corresponding hierarchy cluster and services provided by the management nodes of each of the families of the corresponding hierarchy cluster by:
receiving events from one of the management nodes of the corresponding hierarchy cluster; and
processing the events to obtain the information of the management nodes of the corresponding hierarchy cluster.

15. The system of claim 14, wherein the master node of the corresponding hierarchy cluster is further configured to:
in response to determining, based on the information obtained in processing the events, that a corresponding action is required, control an automation engine in the corresponding hierarchy cluster to perform the corresponding action,
wherein the corresponding action is a resource management action, a remedial management action, or a redundancy management action.

16. The system of claim 15, wherein the automation engine is a service provided by a corresponding one of the management nodes of the corresponding hierarchy cluster, and the master node of the corresponding hierarchy cluster is configured to control the automation engine in the corresponding hierarchy cluster to perform the corresponding action by:
generating a script related to the corresponding action; and
sending the script to the corresponding one of the management nodes of the corresponding hierarchy cluster to control the automation engine to perform the corresponding action.

17. The system of claim 13, wherein the master node of the corresponding hierarchy cluster is configured to perform the automatic addition process by:
receiving an identity profile being advertised by the new computing device, wherein the identity profile includes information identifying the new computing device and information of services provided by the new computing device;
in response to receiving the identity profile, comparing the identity profile with existing identity profiles of the management nodes of the corresponding hierarchy cluster to determine the new computing device as a new management node in a corresponding family of the families of the corresponding hierarchy cluster, and storing the identity profile of the new computing device as the new management node of the corresponding family; and
sending an identifier to the new computing device, wherein the identifier includes information of the corresponding hierarchy cluster, information of the master node of the corresponding hierarchy cluster, and information indicating the new computing device as the new management node of the corresponding family;
wherein the new computing device is configured to advertise the identity profile of the computing device, and to receive the identifier from the master node of the corresponding hierarchy cluster to indicate the new computer as the new management node of the corresponding family.

18. The system of claim 13, wherein the master node of the corresponding hierarchy cluster is further configured to deploy a plurality of manageabilities of the master node to a remote computing device, wherein the remote computing device is an accelerator device or a host computing device of the computing device.

19. The system of claim 12, wherein the one of the plurality of management nodes of a corresponding family of the families of the corresponding hierarchy cluster is configured to:
provide a plurality of services for the corresponding hierarchy cluster; and
receive an instruction from the master node of the corresponding hierarchy cluster to perform peer management and monitor the plurality of management nodes of the corresponding family.

20. The system of claim 19, wherein the services include an automation engine configured to perform a corresponding action based on a script received from the master node of the corresponding hierarchy cluster, and the corresponding action is a resource management action, a remedial management action, or a redundancy management action.
